(19) United States
(12) Patent Application Publication
(10) Pub. No.: US 2019/0384620 A1
(43) Pub. Date: Dec. 19, 2019

(54) INTERACTIVE BUTTON

(71) Applicants: Jory Schwach, New York, NY (US); Matthew Ball, Colchester (GB)

(72) Inventors: Jory Schwach, New York, NY (US); Matthew Ball, Colchester (GB)

(21) Appl. No.: 16/480,791

(22) PCT Filed: Jan. 24, 2018
(86) PCT No.: PCT/US18/15074

§ 371 Date: Jul. 25, 2019

Related U.S. Application Data
(60) Provisional application No. 62/450,464, filed on Jan. 25, 2017.

(51) Int. Cl. G06F 9/451; G06F 9/54; G08B 3/10; G08B 6/00; G08B 5/36; G08B 5/22

(52) U.S. Cl. CPC G06F 9/451; G06F 9/543; G08B 3/1008; G06F 3/048; G08B 5/36; G08B 5/222; G08B 6/00

(57) ABSTRACT

Various embodiments of the present disclosure can include a system. The system can include a computing device. The system can further include an application programming interface in communication with the computing device. The system can further include an interactive button, comprising a processor and a non-transitory computer readable medium that includes instructions executable by the processor. In some embodiments, the instructions can be executable to establish communication between the interactive button and the computing device via the application programming interface. In some embodiments, the instructions can be executable to send an instruction to the computing device from the interactive button via the application programming interface.

### BACKGROUND

Many retail businesses today are reliant on consumers visiting their brick and mortar stores and/or ecommerce stores to purchase products. Oftentimes, retailers can lose business opportunities due to delays in their supply chain. For example, when customers visit a store whether it be brick and mortar or an ecommerce store, if a product is out of stock, a consumer may simply go elsewhere to purchase the product. Furthermore, customers may become frustrated with the retailer, resulting in a less than favorable opinion of the store being held by the customer.

Additionally, even if a customer successfully manages to purchase a product from one of the above mentioned stores, the customer may become frustrated trying to access technical support regarding the product and/or updates regarding the product. For instance, if a customer would like help solving a technical issue with the product, the customer must look up the technical support number and dial in for help. Alternatively, if updates or recalls associated with a product become available, it may be difficult for a user to find the updates or recalls.

### SUMMARY

Various embodiments of the present disclosure can include a system. The system can include a computing device. The system can further include an application programming interface in communication with the computing device. The system can further include an interactive button, comprising a processor and a non-transitory computer readable medium that includes instructions executable by the processor. In some embodiments, the instructions can be executable to establish communication between the interactive button and the computing device via the application programming interface. In some embodiments, the instructions can be executable to send an instruction to the computing device from the interactive button via the application programming interface.

Various embodiments of the present disclosure can include a system. The system can include a computing device. The system can further include an application programming interface in communication with the computing device. The system can further include an interactive button, comprising an indicator, a push button, a processor and a non-transitory computer readable medium that includes instructions executable by the processor. In some embodiments, the instructions can be executable to establish communication between the interactive button and the computing device via the application programming interface. In some embodiments, the instructions can be executable to send an instruction from the computing device to the interactive button via the application programming interface, wherein the instruction causes the indicator to become activated on the interactive button. In some embodiments, the instructions can be executable to receive a selection made via the push button in response to activation of the indicator. In some embodiments, the instructions can be executable to send a computing device instruction to the computing device from the interactive button via the application programming interface in response to the received selection.

Various embodiments of the present disclosure can include a method. In some embodiments, the method can include receiving an instruction with an interactive button, wherein the instruction is sent from a computing device and communicated to the interactive button via an application programming interface. In some embodiments, the method can include activating an indicator disposed on the interactive button in response to receipt of the instruction with the interactive button. In some embodiments, the method can include receiving a selection made by a user of the interactive button in response to activation of the indicator, wherein the selection is made via a push button disposed on the interactive button.

### BRIEF DESCRIPTION OF DRAWINGS

FIG. 1 depicts a system that includes a plurality of interactive buttons that include push buttons, an application programming interface and a computing device, in accordance with embodiments of the present disclosure.

FIG. 2 depicts a system that includes a plurality of interactive buttons that include graphical user interfaces, an application programming interface and a computing device, in accordance with embodiments of the present disclosure.

FIG. 3 depicts a method flow diagram, in accordance with embodiments of the present disclosure.

### DETAILED DESCRIPTION

Embodiments of the present disclosure are described below with reference to the accompanying figures and include systems, methods, and apparatuses. The features and advantages that are explained are illustrated by way of example, and not by way of limitation. One of ordinary skill in the art will recognize that there are additional features and advantages provided by this invention beyond those described herein.

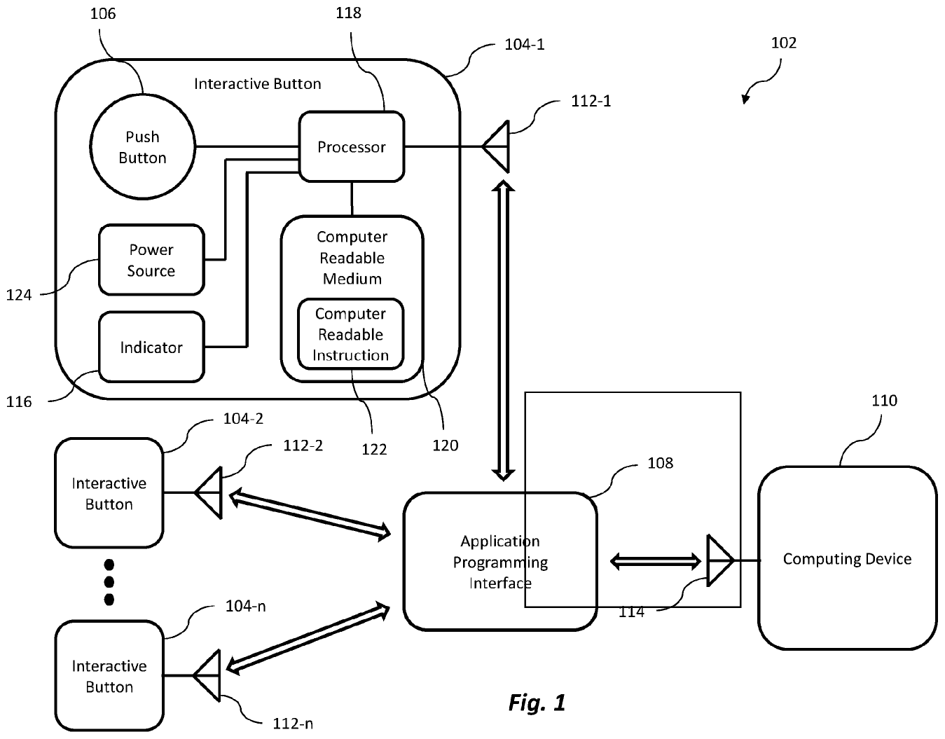

FIG. 1 depicts a system 102 that includes a plurality of interactive buttons 104-1, 104-2, 104-n that include push buttons (e.g., push button 106), an application programming interface (API) 108 and a computing device 110, in accordance with embodiments of the present disclosure. In some embodiments, the interactive buttons 104-1, 104-2, 104-n, hereinafter referred to in the plural as interactive buttons 104, can be in communication with the computing device 110 via a wireless or wired communication link. For example, the interactive buttons 104 can be in communication with the computing device 110 via antennas 112-1, 112-2, 112-n and antenna 114. Although not depicted, the interactive buttons 104 can be in communication with the computing device 110 via a wired connection. In an example, the interactive buttons 104 can be in wireless communication with the computing device 110 via Bluetooth, Wi-Fi, radio signals, etc. Although more than one interactive button 104 is depicted, embodiments of the present disclosure can include one or more interactive buttons 104 in communication with the computing device 110.

Embodiments of the present disclosure can establish communication between one or more of the plurality of interactive buttons 104 and the computing device 110. In an example, the interactive buttons 104 can have one or more input devices that can receive a selection from a user, such as push button 106. If the user pushes push button 106, communication can be established with the computing device 110 via the API 108. In an example, the communication can include instructions that are sent to the computing device 110, which can cause the computing device 110 to provide an indication to an entity associated with the computing device 110 to call and/or otherwise establish communication with the user. For example, an indication can be provided to a customer service representative and/or an automated telephone bank to call and/or contact the customer.

In some embodiments, a customer may be prompted to depress the push button in response to an indicator 116 associated with the interactive button 104-1 being activated. In an example, the computing device 110 can communicate with the interactive button 104, providing an instruction to the interactive button 104 to activate the indicator 116. The indicator 116 can be a light, vibration inducing element, speaker, etc., which can be activated to alert a user. In an example, the alert can indicate that the entity associated with the computing device 110 has information for the user. For example, the information can be information associated with a product that the user has bought, such as recall information, promotional information associated with products related to the product that the user bought, etc.

In an example where the indicator is a light, the light can be activated in response to receipt of instructions from the computing device 110. Via the indicator light, the user can be informed that the entity associated with the computing device 110 has information for the user. The user can then depress the push button 106, which can send instructions to the computing device 110 (e.g., via the antennas 112-1, 114). In an example, the instructions can prompt the entity associated with the computing device 110 or another third party to call and/or contact the user with the information. This can allow for the information from the entity associated with the computing device 10 or another third party to be provided to the user at a time that is convenient for the user. As further depicted, in relation to FIG. 1, the interactive button 104-1 can include a processor 118 and non-transitory computer readable medium 120, which can store computer readable instructions 122 that are executable by the processor 118 to perform a particular function (e.g., activate the indicator 116, send instructions to the computing device 110).

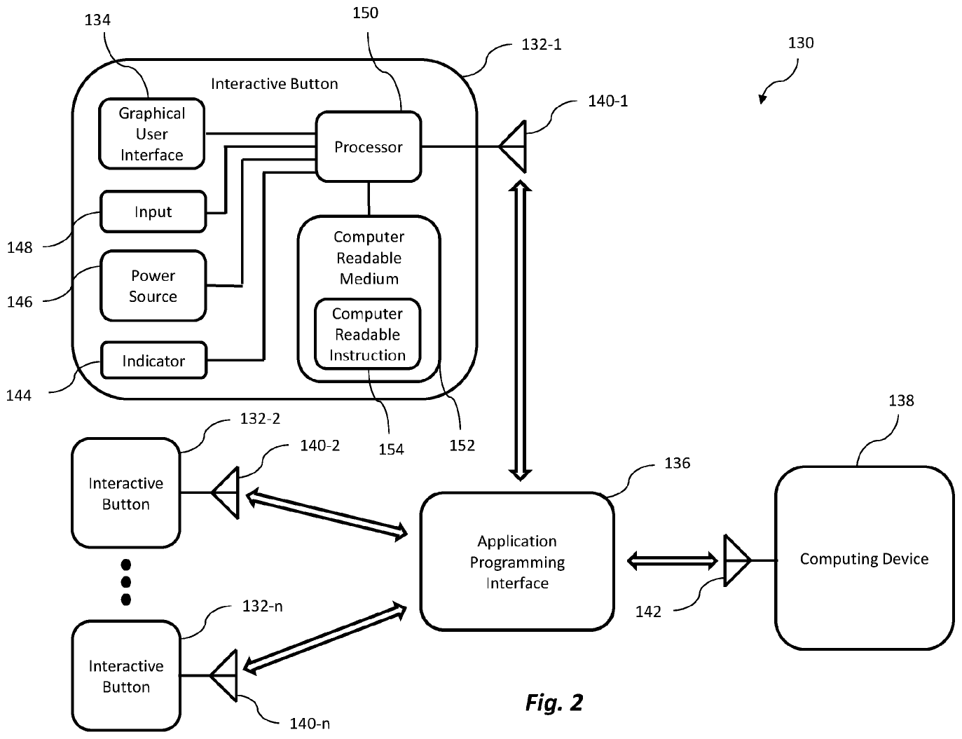

In some embodiments, data can be transferred from the computing device 110 to the interactive button 104 via the computing device antenna 114, the application programming interface 108 and the antenna 112 associated with the interactive button 104. For instance, data that can be displayed on a graphical user interface associated with the interactive button 104, further discussed in relation to FIG. 2, and/or a voice message can be transferred to the interactive button and stored on the computer readable medium 120. The indicator 116 can be activated in response to the receipt of the data. The user can then depress the push button 106, causing the data to be displayed and/or announced via a graphical user interface and/or speaker associated with the interactive button 104.

In some embodiments, the interactive button 104-1 can include a power source 124. As depicted, the power source 124 can be internal, such as an internal battery. However, in some embodiments, the power source 124 can be external and can provide power to the interactive button 104-1 via a wired or wireless connection.

In some embodiments, the interactive button 104-1 can be registered, which can allow for identifying information associated with the user and/or contact information associated with the user to be associated with the interactive button 104-1. For example, the interactive button 104-1 can be registered with the user, such that when the user depresses the push button 106 and/or otherwise causes the interactive button 104-1 to send instructions to the computing device 110, contact information associated with the user can be provided to the computing device 110 for use in contacting the user. In some embodiments, a unique identification code associated with the interactive button 104-1 can be associated with the user and/or the user's contact information.

In some embodiments, the push button 106 can be depressed when the indicator 116 is not activated. In this scenario, a request can be sent to the computing device 110. In an example, the request sent to the computing device 110 when the indicator 116 is not activated can be different than the request sent to the computing device 110 when the indicator 116 is activated. For example, when the indicator 116 is not activated, the request can include instructions for the entity to contact the user of the interactive button for a different reason. For instance, the instructions can prompt the entity to contact the user for technical support reasons, etc. However, when the user depresses the push button 106 when the indicator 116 is activated, the instructions can prompt the entity to contact the user with promotional materials, or another reason.

FIG. 2 depicts a system 130 that includes a plurality of interactive buttons 132-1, 132-2, 132-n that include graphical user interfaces (e.g., graphical user interface 134), an application programming interface (API) 136 and a computing device 138, in accordance with embodiments of the present disclosure. The interactive buttons 132-1, 132-2, 132-n, hereinafter referred to in the plural as interactive buttons 132, can communicate with the computing device 138 via a wired or wireless connection.

In some embodiments, the computing device 138 can communicate with the interactive buttons 132 via a wired or wireless communication link. For example, the interactive buttons 132 can be in communication with the computing device 138 via antennas 140-1, 140-2, 140-n and antenna 142. Although not depicted, the interactive buttons 132 can be in communication with the computing device 138 via a wired connection. In an example, the interactive buttons 132 can be in wireless communication with the computing device 138 via Bluetooth, Wi-Fi, radio signals, etc., as previously discussed.

In some embodiments, the interactive button 132-1 can include a graphical user interface 134, which can display information to a user. For instance, an entity associated with the computing device 138 can send information to the interactive button 132-1, which can cause an indicator 144, analogous to that discussed in relation to FIG. 1, to be activated and/or can display information on the graphical user interface 134. In an example, information displayed on the graphical user interface 134 can include promotional material related to products sold by the entity associated with the computing device 138 and/or another third party. In some embodiments, the promotional material can relate to products that are currently in stock and/or can currently be shipped. For example, in some embodiments, the indicator 144 can be activated to notify the user that a message and/or promotional information is available. In an example, the message and/or promotional information can be displayed to the user via the graphical user interface 134. In some embodiments, the indicator 144 and/or the input 148 can be incorporated into the graphical user interface 134.

In some embodiments, the indicator 144 can initially be activated to indicate to the user that a product or other information is available. A selection can be received by the interactive button 132-1 from the user to display the information on the graphical user interface 134. By displaying the information upon receipt of a prompt received from a user, energy can be conserved by the device, which can be important when a power source 146 of the interactive button 132 is a battery. However, in some embodiments, the graphical user interface 134 and/or the indicator 144 can be activated to notify the user that a message and/or promotional information is available, upon receipt of the information. Accordingly, the user may not have to make a selection to view the information on the graphical user interface.

In some embodiments, if the user wishes to act on the message or promotional information, a user selection can be received via the graphical user interface 134 and/or via an input 148. For example, if the message and/or promotional information includes information that a product is in stock, a user can choose to purchase the product by making a selection via the graphical user interface 134 and/or the input 148. In response to the selection made by the user, instructions can be sent to the computing device 138 via the antennas 140-1, 140-2, 140-n, and 142 and the API 136 to purchase the product and ship the product to the user. As further depicted, in relation to FIG. 2, the interactive button 132-1 can include a processor 150 and non-transitory computer readable medium 152, which can store computer readable instructions 154 that are executable by the processor 150 to perform a particular function (e.g., activate the indicator 144, send instructions to the computing device 138).

In some embodiments, the interactive button 132-1 can be registered to the user. This can allow for identifying information associated with a user and/or contact information associated with the user to be associated with the interactive button 132-1. For example, the interactive button 132-1 can be registered with the user, such that when the user makes a selection via the input 148 and/or the graphical user interface 134, and/or otherwise causes the interactive button 132-1 to send instructions to the computing device 138, contact information associated with the user can be provided for use in contacting the user. Additional information can be registered with the device and/or user, such as payment information that includes a credit card number, bank account information, etc.

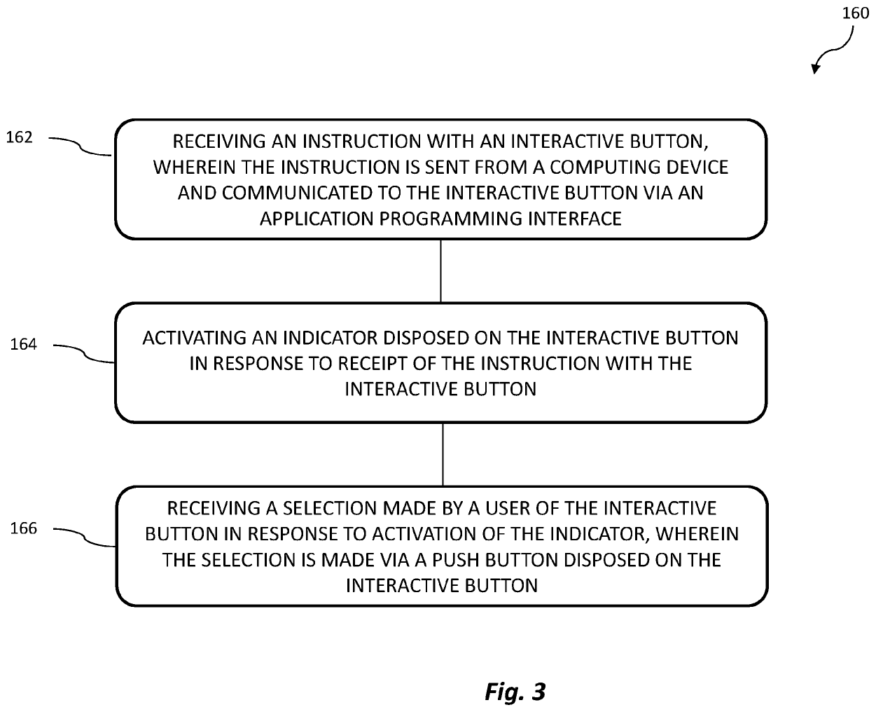

FIG. 3 depicts a method 160 flow diagram, in accordance with embodiments of the present disclosure. In some embodiments, the method 160 can include receiving 162 an instruction with an interactive button. As discussed herein, the interactive button can be in communication with a computing device via an application programming interface. The interactive button, the computing device, and the application programming interface can be connected via a wireless and/or a wired connection in some embodiments. In an example, the instruction can be sent from the computing device and communicated to the interactive button via the application programming interface over the wired and/or wireless connection. The method 160 can include activating 164 an indicator disposed on the interactive button in response to receipt of the instruction with the interactive button. As discussed herein, the indicator can be a light, speaker, vibration inducing element, etc., which can be activated to alert a user.

In some embodiments, the indicator can indicate that information is available to a user, as discussed herein. For example, the information can include information associated with a product owned by the user of the interactive button. In some embodiments, the information can include information associated with promotional material directed to the user. For example, the promotional material can be for a product that an entity associated with the computing device wishes to market and/or sell to the user.

In some embodiments, the method 160 can include receiving 166 a selection made by a user of the interactive button in response to activation of the indicator. The selection can be made via a push button disposed on the interactive button. In some embodiments, the method can include providing the information to the user of the interactive button in response to receiving the selection made by the user of the interactive button in response to activation of the indicator. For example, in some embodiments, a user can be alerted by the indicator, which can provide a signal to the user that information is available to the user. The user can then access the available information by making a selection via the interactive button. In response to the selection, information can be displayed (e.g., via a graphical user interface), announced, etc. via the interactive button. In some embodiments, an indication can be provided to an entity associated with the computing device to contact the user (e.g., via telephone, email, text message, directed mailing, etc.) and provide the user the information in response to receipt of the selection made with the interactive button.

Embodiments are described herein of various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to “various embodiments,” “some embodiments,” “one embodiment,” or “an embodiment”, or the like, means that a particular feature, structure, or characteristic described in connection with the embodiment(s) is included in at least one embodiment. Thus, appearances of the phrases “in various embodiments,” “in some embodiments,” “in one embodiment,” or “in an embodiment,” or the like, in places throughout the specification, are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features, structures, or characteristics of one or more other embodiments without limitation given that such combination is not illogical or non-functional.

What is claimed:

1. A system, comprising:
a computing device;
an application programming interface in communication with the computing device; and
an interactive button, comprising a processor and a non-transitory computer readable medium that includes instructions executable by the processor to:
establish communication between the interactive button and the computing device via the application programming interface; and
send an instruction to the computing device from the interactive button via the application programming interface.

2. The system of claim 1, wherein the instruction is sent to the computing device from the interactive button via the application programming interface in response to a push button being pushed.

3. The system of claim 1, wherein establishing communication between the interactive button and the computing device includes providing an indication to an entity associated with the computing device.

4. The system of claim 3, wherein the indication includes instructions for the entity to call a user associated with the interactive button.

5. The system of claim 1, further comprising instructions stored on the computer readable medium and executable by the processor to register information associated with a user of the interactive button with the interactive button.

6. The system of claim 1, further comprising instructions stored on the computer readable medium and executable by the processor to receive an instruction to activate an indicator included on the interactive button.

7. The system of claim 6, wherein the indicator is at least one of a light, vibration inducing element, and a speaker.

8. The system of claim 7, wherein the indicator indicates that an entity associated with the computer has information for the user.

9. The system of claim 8, wherein receipt of a user selection of the push button while the indicator is activated causes instructions to be sent to the computing device.

10. The system of claim 9, wherein the instructions sent to the computing device prompt an entity associated with the computing device to contact the user.

11. The system of claim 1, wherein the computing device, application programming interface, and interactive button are wirelessly connected with one another.

12. A system, comprising:
a computing device;
an application programming interface in communication with the computing device; and
an interactive button, comprising an indicator, a push button, a processor and a non-transitory computer readable medium that includes instructions executable by the processor to:
establish communication between the interactive button and the computing device via the application programming interface;
send an instruction from the computing device to the interactive button via the application programming interface, wherein the instruction causes the indicator to become activated on the interactive button;
receive a selection made via the push button in response to activation of the indicator; and
send a computing device instruction to the computing device from the interactive button via the application programming interface in response to the received selection.

13. The system of claim 12, wherein the computing device instruction sent to the computing device from the interactive button provides an indication to an entity associated with the computing device.

14. The system of claim 13, wherein the indication includes instructions for the entity to contact a user associated with the interactive button.

15. A method, comprising:
receiving an instruction with an interactive button, wherein the instruction is sent from a computing device and communicated to the interactive button via an application programming interface;
activating an indicator disposed on the interactive button in response to receipt of the instruction with the interactive button; and
receiving a selection made by a user of the interactive button in response to activation of the indicator, wherein the selection is made via a push button disposed on the interactive button.

16. The method of claim 15, further comprising indicating that information is available to the user of the interactive button through activation of the indicator.

17. The method of claim 16, further comprising providing the information to the user of the interactive button in response to receiving the selection made by the user of the interactive button in response to activation of the indicator.

18. The method of claim 17, further comprising providing the information to the user via a graphical user interface disposed on the interactive button.

19. The method of claim 17, further comprising providing an indication to an entity associated with the computing device to contact the user of the interactive button with the information.

20. The method of claim 15, wherein activating the indicator includes activating at least one of a light, a speaker, and a vibration inducing element.
